(19) United States
(12) Patent Application Publication
(10) Pub. No.: US 2024/0160827 A1
(43) Pub. Date: May 16, 2024

(54) METHODS OF TRAINING DEEP LEARNING MODELS FOR OPTICAL PROXIMITY CORRECTION, OPTICAL PROXIMITY CORRECTION METHODS, AND METHODS OF MANUFACTURING SEMICONDUCTOR DEVICES USING THE SAME

(71) Applicant: Samsung Electronics Co., Ltd., Suwon-si (KR)

(72) Inventor: Sangchul Yeo, Suwon-si (KR)

(21) Appl. No.: 18/341,124

(22) Filed: Jun. 26, 2023

(30) Foreign Application Priority Data
Nov. 14, 2022 (KR) 10-2022-0151854

(51) Int. Cl. G06F 30/398; G03F 1/36; H01L 21/027

(52) U.S. Cl. CPC G06F 30/398; G03F 1/36; H01L 21/0273; G06F 2119/18

(57) ABSTRACT

In a method of training a deep learning model for optical proximity correction, sample input images associated with sample layouts may be obtained, where the sample layouts are targets of the optical proximity correction. Sample reference images that correspond to the sample input images may be extracted from sample masks that are fabricated by performing the optical proximity correction on the sample layouts. A training operation may be performed on the deep learning model used in the optical proximity correction based on the sample input images and the sample reference images. The sample layouts may include sample layout patterns to form process patterns of a semiconductor device. The sample input images may include images of corner portions of the sample layout patterns. The deep learning model may be used to perform a corner rounding operation on the corner portions of the sample layout patterns.

### CROSS-REFERENCE TO RELATED APPLICATION

This application claims priority under 35 USC § 119 to Korean Patent Application No. 10-2022-0151854 filed on Nov. 14, 2022, in the Korean Intellectual Property Office (KIPO), and the entire contents of the above-identified application are incorporated by reference herein.

### BACKGROUND

### 1. Technical Field

Aspects of the present disclosure relate generally to semiconductor integrated circuits, and more particularly to methods of training deep learning models for optical proximity correction, optical proximity correction methods, and methods of manufacturing semiconductor devices using the methods of training the deep learning models.

### 2. Description of the Related Art

Semiconductor devices are widely used in electronics industries due to their small sizes, multi-functional characteristics, and/or low manufacture costs. As the electronics industries have been developed, demand has increased for semiconductor devices with excellent characteristics. For example, demand has increased rapidly for high-reliable, high-speed, and/or multi-functional semiconductor devices. To satisfy these demands, semiconductor devices have become highly integrated, and structures of semiconductor devices have become more complicated.

Semiconductor devices may be manufactured through a photolithography process. Layout patterns may be printed or implemented on a semiconductor substrate by the photolithography process. As semiconductor devices have become highly integrated, distances have been reduced between layout patterns of masks used to manufacture or fabricate the semiconductor devices. For example, the layout patterns may be very close to each other due to reduced distances therebetween. The layout patterns, when close to each other, may cause interference and diffraction of light such that a distorted layout is printed on a semiconductor substrate rather than a desired layout. To address these problems, resolution enhancement technology (e.g., optical proximity correction) may be used for preventing the distortion of the layout patterns.

### SUMMARY

Aspects of the present disclosure provide methods of training a deep learning model for optical proximity correction capable of efficiently training or learning a corner rounding associated with layout patterns in a semiconductor designing/manufacturing phase.

At least one example embodiment of the present disclosure provides an optical proximity correction method and a method of manufacturing a semiconductor device using the method of training the deep learning model.

According to example embodiments, in a method of training a deep learning model used in optical proximity correction to correct a layout pattern used in semiconductor device fabrication, sample input images may be obtained that are associated with sample layouts, where the sample layouts are targets of the optical proximity correction. Sample reference images that correspond to the sample input images may be extracted from sample masks that are fabricated by performing the optical proximity correction on the sample layouts. A training operation may be performed on the deep learning model used in the optical proximity correction based on the sample input images and the sample reference images. The sample layouts may include sample layout patterns to form process patterns of a semiconductor device. The sample input images may include images of corner portions of the sample layout patterns. The deep learning model may be used to perform a corner rounding operation on the corner portions of the sample layout patterns.

According to example embodiments, in an optical proximity correction method, a design layout including layout patterns used in a semiconductor process to form process patterns of a semiconductor device is received. An optical proximity correction model associated with the design layout is obtained based on a deep learning model used in optical proximity correction. A corrected design layout including corrected layout patterns that correspond to the layout patterns is obtained based on the optical proximity correction model. The deep learning model is trained by obtaining sample input images associated with sample layouts, the sample layouts being targets of the optical proximity correction, by extracting sample reference images that correspond to the sample input images from sample masks that are fabricated by performing the optical proximity correction on the sample layouts, and by performing a training operation on the deep learning model based on the sample input images and the sample reference images. The sample layouts include sample layout patterns, and the sample input images include images of corner portions of the sample layout patterns. The deep learning model is used to perform a corner rounding operation on the corner portions of the sample layout patterns and corner portions of the layout patterns.

According to some example embodiments, in a method of manufacturing a semiconductor device, a design layout including layout patterns used in a semiconductor process to form process patterns of the semiconductor device is obtained. A corrected design layout including corrected layout patterns that correspond to the layout patterns is formed by performing optical proximity correction on the design layout. A photomask is fabricated based on the corrected design layout. The process patterns are formed on a substrate using the photomask. When forming the corrected design layout, the design layout is received. An optical proximity correction model associated with the design layout is obtained based on a deep learning model used in the optical proximity correction. The corrected design layout is obtained based on the optical proximity correction model. The deep learning model is trained by obtaining sample input images associated with sample layouts, where the sample layouts are targets of the optical proximity correction, by extracting sample reference images that correspond to the sample input images from sample masks that are fabricated by performing the optical proximity correction on the sample layouts, and by performing a training operation on the deep learning model based on the sample input images and the sample reference images. The sample layouts include sample layout patterns, and the sample input images include images of corner portions of the sample layout patterns. The deep learning model is used to perform a corner rounding operation on the corner portions of the sample layout patterns and corner portions of the layout patterns.

In the methods of training the deep learning model for optical proximity correction, the optical proximity correction methods, and the methods of manufacturing semiconductor devices according to example embodiments, the deep learning model used to perform the corner rounding operation in the optical proximity correction may be trained using data related to photomasks that have already been applied in real or actual manufacturing processes of the semiconductor devices (e.g., photomasks that have already been actually fabricated). Thereafter, the optical proximity correction including the corner rounding operation may be performed using the trained deep learning model, and a photomask, which has not yet been applied to the manufacturing process of a semiconductor device and will be newly applied to the manufacturing process of the semiconductor device, may be fabricated based on a result of the optical proximity correction. Accordingly, the accuracy of the correction may be improved or enhanced, and the process margin may also be improved or enhanced.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of training a deep learning model for optical proximity correction according to some example embodiments.

FIGS. 2 and 3 are block diagrams illustrating a system performing a method of training a deep learning model for optical proximity correction and/or an optical proximity correction method according to some example embodiments.

FIGS. 4A, 4B, 4C, 4D, 4E, 5A, 5B and 5C are diagrams for describing a deep learning model used in a method of training a deep learning model for optical proximity correction and/or an optical proximity correction method according to some example embodiments.

FIG. 6 is a flowchart illustrating an example of performing a training operation in FIG. 1.

FIGS. 7A, 7B, 7C and 7D are diagrams for describing an operation of FIG. 6.

FIG. 8 is a flowchart illustrating an example of performing a training operation in FIG. 1.

FIG. 9 is a flowchart illustrating an optical proximity correction method according to some example embodiments.

FIG. 10 is a flowchart illustrating an example of obtaining an optical proximity correction model in FIG. 9.

FIG. 11 is a flowchart illustrating an example of generating an optical proximity correction model in FIG. 10.

FIGS. 12A, 12B, 12C and 12D are diagrams for describing an optical proximity correction method according to some example embodiments.

FIG. 13 is a flowchart illustrating a method of manufacturing a semiconductor device according to some example embodiments.

FIGS. 14A, 14B and 14C are diagrams for describing a method of manufacturing a semiconductor device according to some example embodiments.

FIG. 15 is diagram illustrating an example of a layout of a semiconductor device manufactured by a method of manufacturing a semiconductor device according to some example embodiments.

### DETAILED DESCRIPTION OF THE EMBODIMENTS

Various example embodiments will be described more fully with reference to the accompanying drawings, in which some examples of embodiments are shown. The present disclosure may, however, be embodied in many different forms and should not be construed as limited to the embodiments set forth herein. Like reference numerals refer to like elements throughout this application.

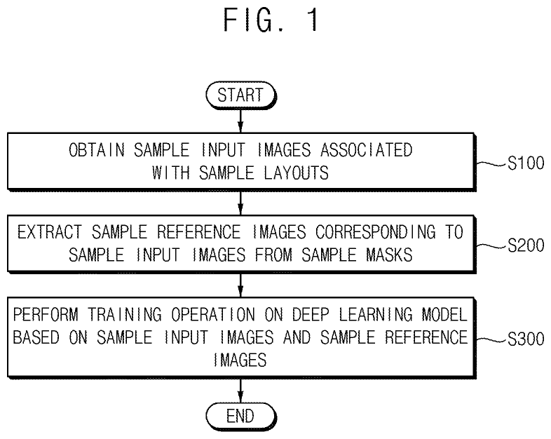

FIG. 1 is a flowchart illustrating a method of training a deep learning model for optical proximity correction according to some example embodiments.

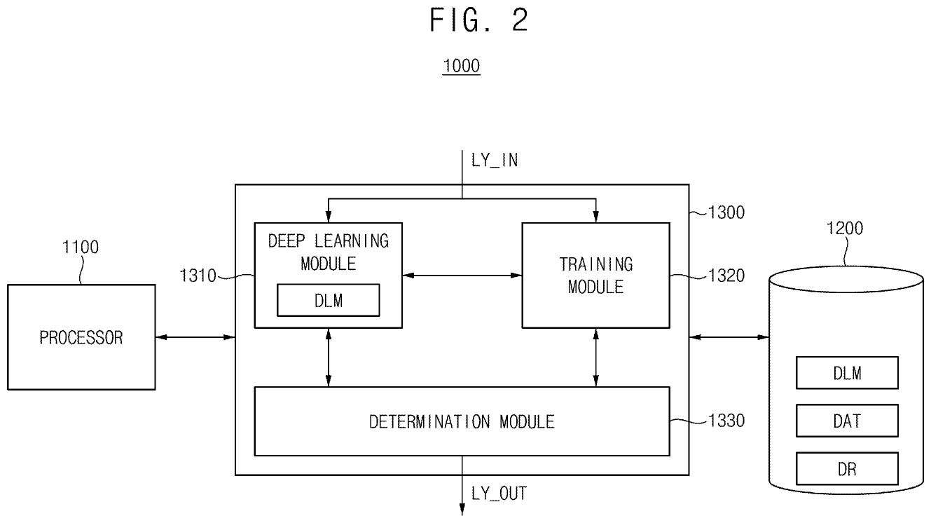

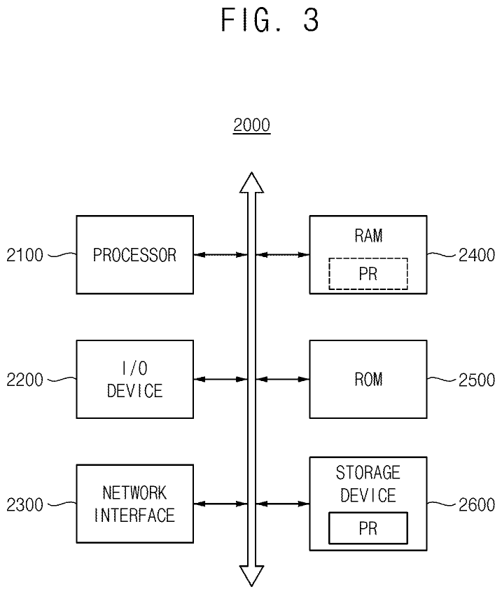

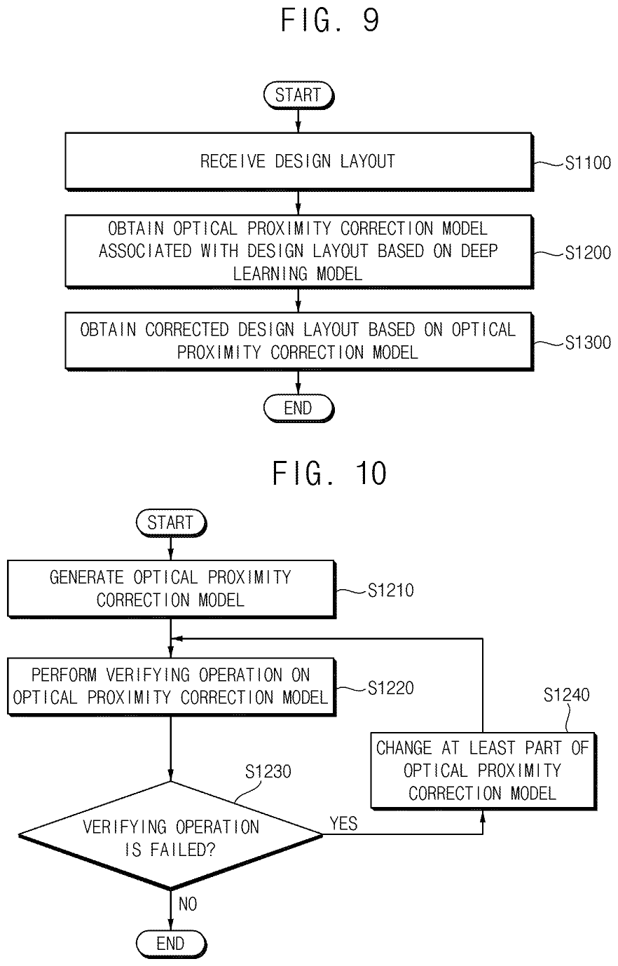

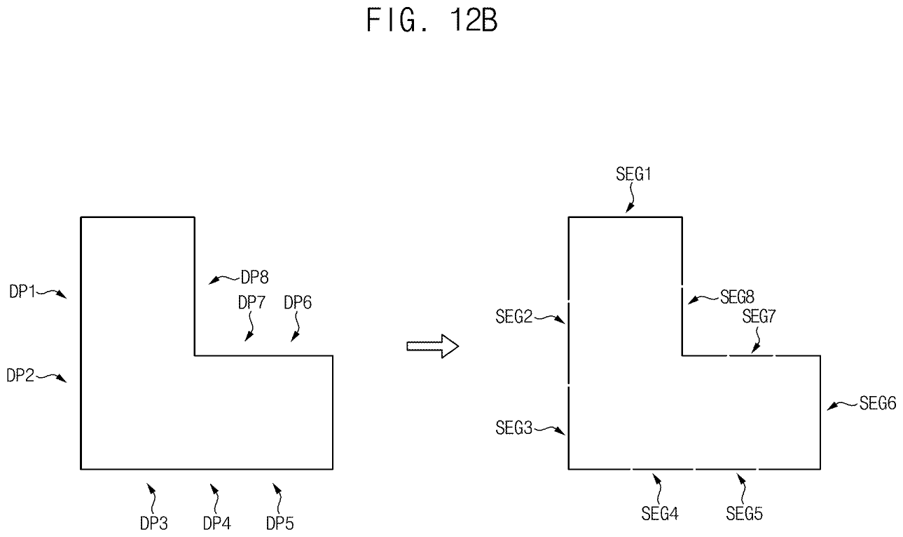

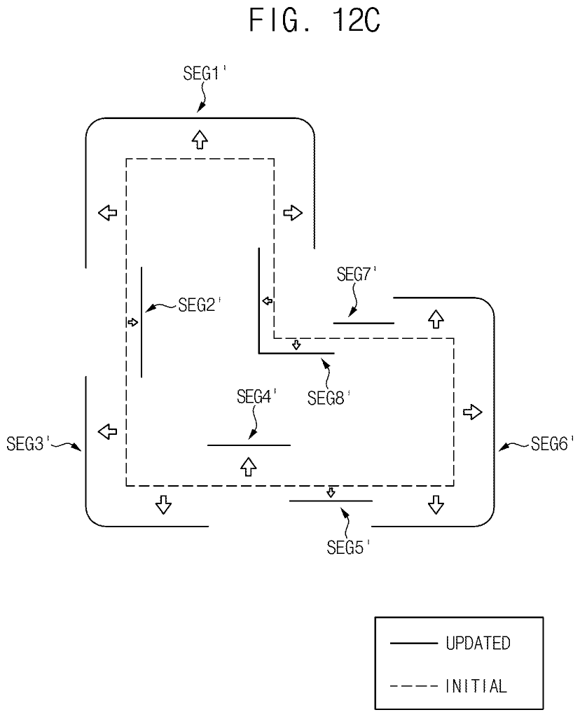

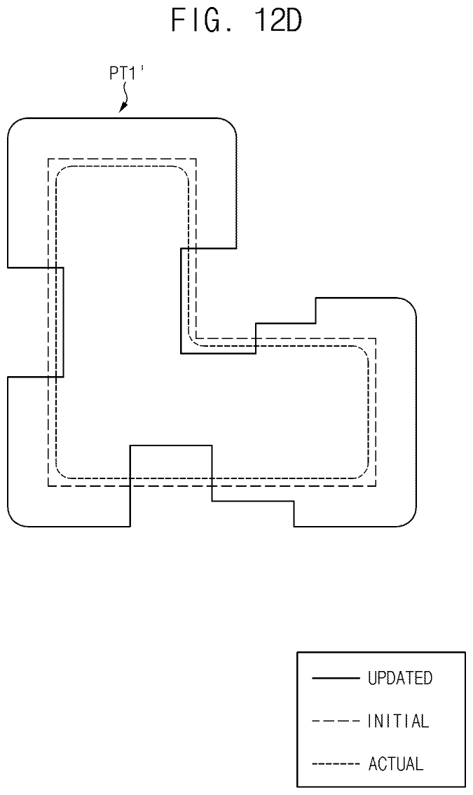

Referring to FIG. 1, a method of training a deep learning model for optical proximity correction according to some example embodiments may be performed in a semiconductor designing/manufacturing phase or during a designing/manufacturing procedure of a semiconductor device (or semiconductor integrated circuit). For example, the method of training the deep learning model for optical proximity correction according to some example embodiments may be used to train or learn a deep learning model used in optical proximity correction (OPC), which is a type of layout correction, and may be performed by a system and/or a tool for optical proximity correction (or layout correction) and/or semiconductor design. For example, the system and/or the tool for optical proximity correction and/or semiconductor design may be a program (or program code) that includes a plurality of instructions executed by at least one processor. The system and/or the tool will be described with reference to FIGS. 2 and 3, and the optical proximity correction will be described with reference to FIGS. 9, 12A, 12B, 12C and 12D.

In the method of training the deep learning model for optical proximity correction according to example embodiments, sample input images associated with or related to sample layouts that are targets of the optical proximity correction may be obtained or acquired (operation S100). For example, the sample layouts may include sample layout patterns to form process patterns of the semiconductor device, and the sample input images may include images of the sample layout patterns.

Sample reference images corresponding to the sample input images may be extracted from sample masks that are fabricated by performing the optical proximity correction on the sample layouts (operation S200). For example, the sample masks may be photomasks. For example, the sample masks may include sample mask patterns to form the process patterns of the semiconductor device, and the sample reference images may include images of the sample mask patterns.

In some example embodiments, the sample layout patterns included in the sample layouts may correspond to patterns of a photomask, the sample layouts may be corrected by performing the optical proximity correction, and the sample masks (e.g., photomasks) may be fabricated using the corrected sample layouts. For example, the sample layouts may be target layouts of photoresist patterns required to be obtained in after-development inspection (ADI), and the corrected sample layouts may be layouts of the photomask.

In some example embodiments, the sample masks may be photomasks that are actually fabricated based on the sample layouts, and may be photomasks that have already been applied to real manufacturing process (or physical processes) of the semiconductor device. As used herein, “real (or physical) processes” may refer to processes that are actually performed by mechanical equipment. For example, the optical proximity correction has been performed on the sample layouts, the sample masks have been fabricated using the corrected sample layouts, and the semiconductor device has been manufactured using the fabricated sample masks.

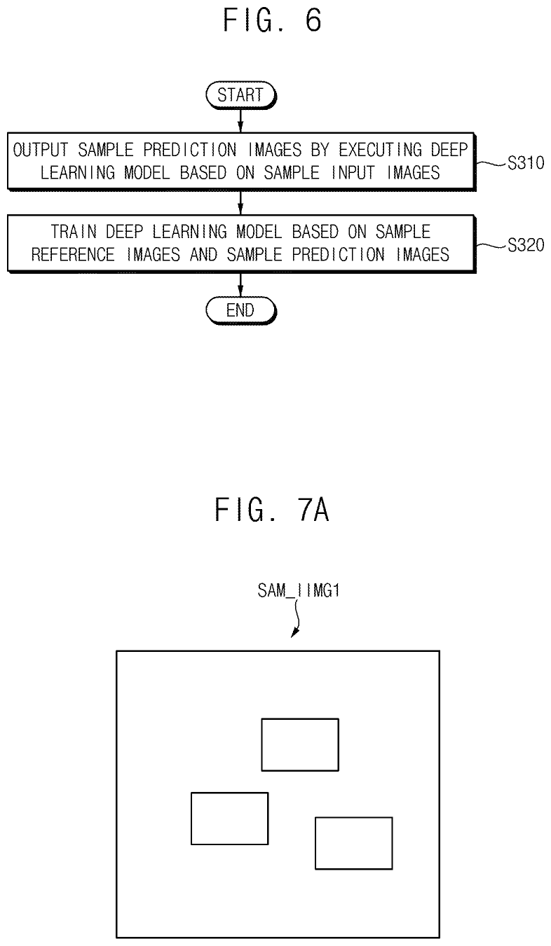

A training (or learning) operation may be performed on the deep learning model used in the optical proximity correction based on the sample input images and the sample reference images (operation S300). For example, sample prediction images may be generated by executing the deep learning model based on the sample input images, and the deep learning model may be trained based on the sample reference images and the sample prediction images. In other words, the deep learning model may be trained using data related to the photomask that has already been applied to the real manufacturing process of the semiconductor device (e.g., the photomask that has already been actually fabricated). Operation S300 will be described with reference to FIGS. 6 and 8.

In some example embodiments, the sample input images may include images of corner portions (or simply corners) of the sample layout patterns, and the sample reference images may include images of corner portions or corners of the sample mask patterns. Thus, the deep learning model may be used to or implemented to perform a corner rounding operation on the corner portions of the sample layout patterns.

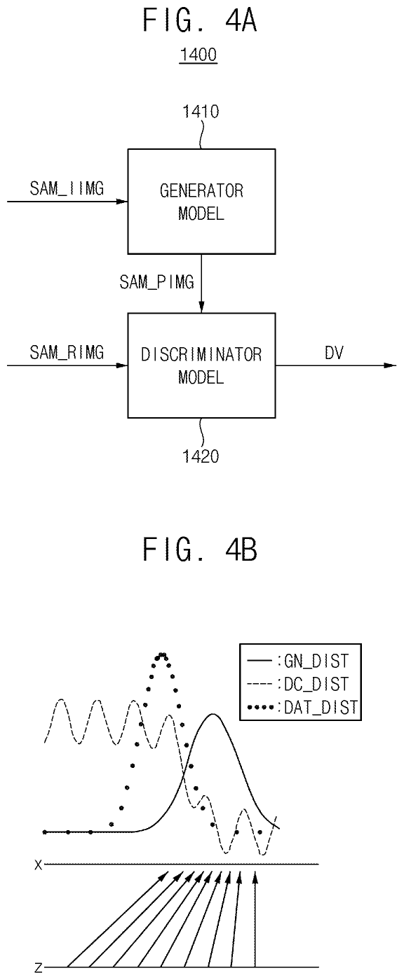

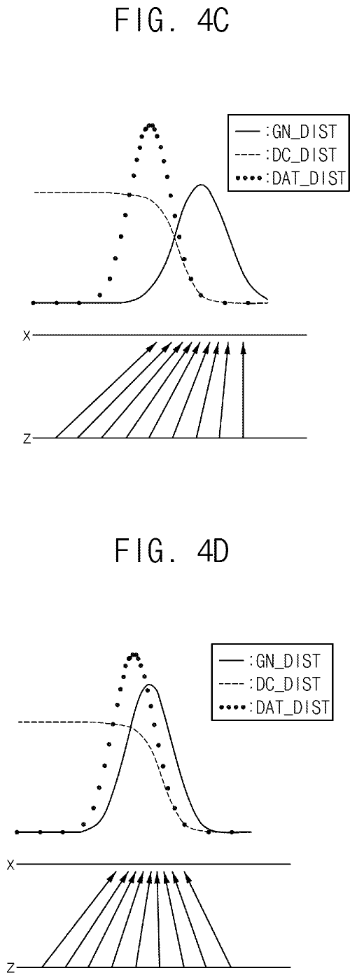

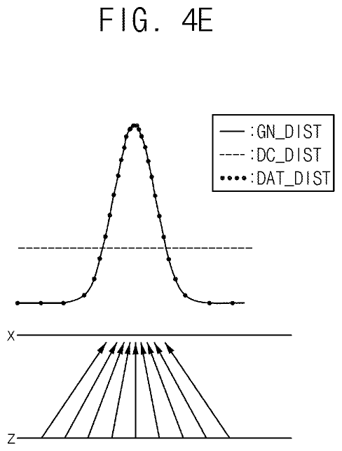

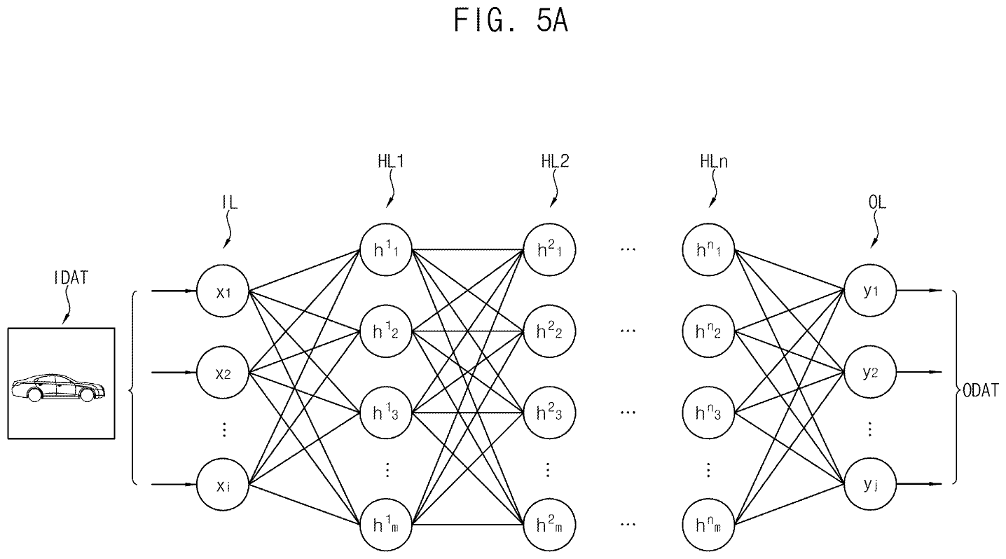

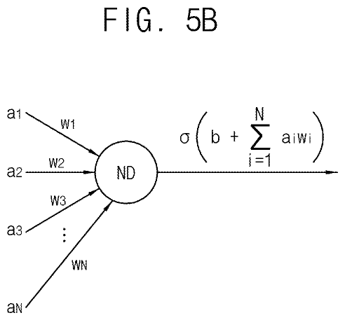

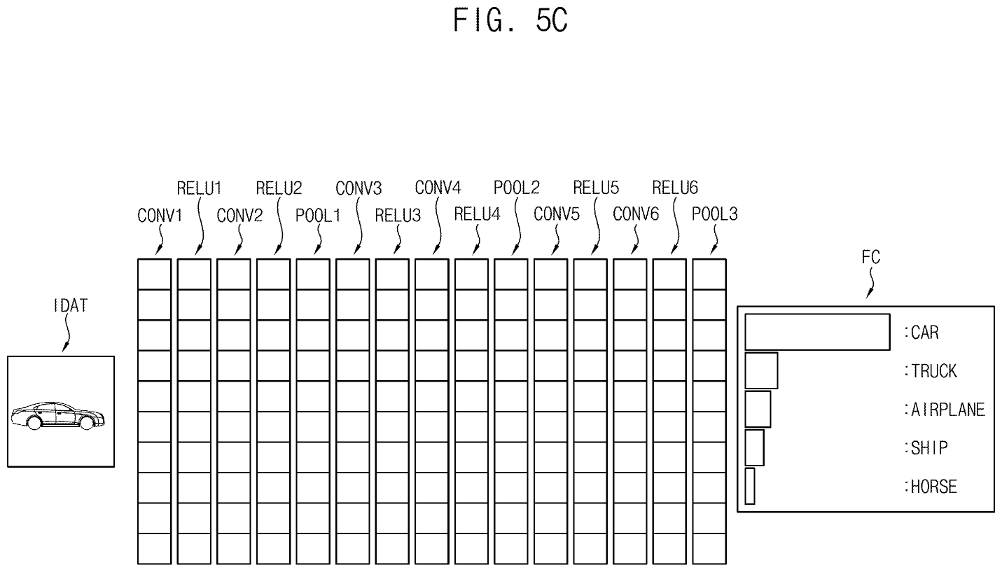

In some example embodiments, the deep learning model may be a generative adversarial network (GAN). For example, the deep learning model may be a convolutional generative adversarial network that is implemented based on a convolutional operation and/or a convolutional neural network (CNN) to be appropriate or suitable for an image processing operation. A configuration of the deep learning model will be described with reference to FIGS. 4A, 4B, 4C, 4D, 4E, 5A, 5B and 5C.

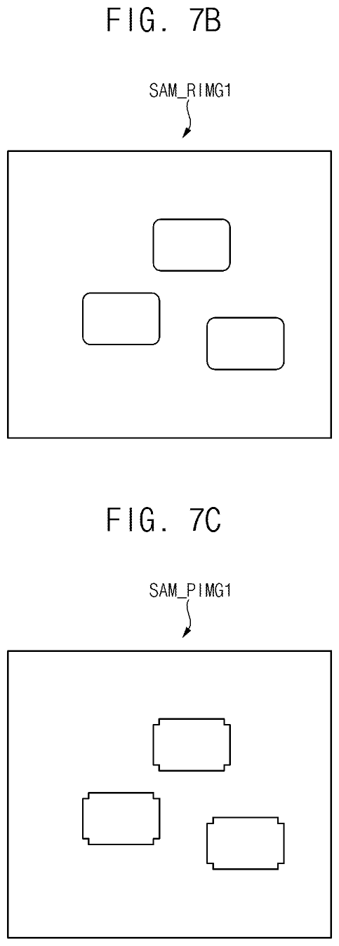

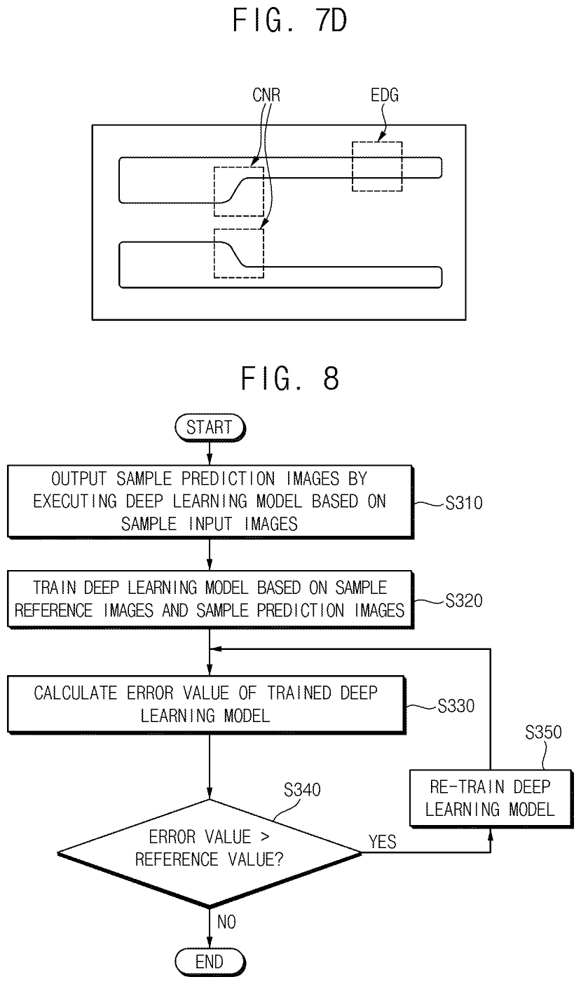

The sample input images, the sample reference images, and the sample prediction images that are used in the training operation of the deep learning model will be described with reference to FIGS. 7A, 7B, 7C and 7D.

In some example embodiments, as will be described with reference to FIG. 9, the optical proximity correction may be performed based on or using the trained deep learning model. For example, when a photomask, which has not yet been applied to the manufacturing process of a semiconductor device and will be newly applied to the manufacturing process of the semiconductor device, is to be fabricated, the optical proximity correction may be performed on layout patterns included in a design layout for fabricating the photomask, and the corner rounding operation may be performed on corner portions of the layout patterns using the trained deep learning model.

A layout of a semiconductor device may include a plurality of layout patterns, circuit patterns and/or corresponding polygons for semiconductor processes to form process patterns (or semiconductor patterns) of the semiconductor device when manufacturing the semiconductor device. In the semiconductor designing phase, portions of the process patterns to be distorted may be expected or predicted, the layout patterns may be modified based on the expected distortions in advance to the real semiconductor, and the modified layout patterns may be reflected in the layout.

The optical proximity correction may compensate for distortion of the photoresist patterns by effects from etching skew and/or effects of characteristics of the patterns while the photoresist patterns are formed. For example, the optical proximity correction may expect portions of the patterns to be distorted and may modify the expected distortions in advance to compensate for the distortion arising from physical semiconductor processes such as the etching process.

In the optical proximity correction, it may be desirable to apply a corner rounding operation depending on mask processes and shapes of patterns. Conventionally, the corner rounding operation has been performed empirically, and there was a problem in that the accuracy of the correction was relatively low.

In the method of training the deep learning model for optical proximity correction according to some example embodiments, the deep learning model used to perform the corner rounding operation in the optical proximity correction may be trained using the data related to photomasks that have already been applied to the real manufacturing process of the semiconductor device (e.g., photomasks that have already been actually fabricated). Thereafter, the optical proximity correction including the corner rounding operation may be performed using the trained deep learning model, and a photomask, which has not yet been applied to the manufacturing process of the semiconductor device and will be newly applied to the manufacturing process of the semiconductor device, may be fabricated based on a result of the optical proximity correction. Accordingly, the accuracy of the correction may be improved or enhanced, and the process margin may also be improved or enhanced.

FIGS. 2 and 3 are block diagrams illustrating a system performing a method of training a deep learning model for optical proximity correction and/or an optical proximity correction method according to example embodiments.

Referring to FIG. 2, a system 1000 may include a processor 1100, a storage device 1200 and an optical proximity correction module (or layout correction module) 1300.

Herein, the term “module” may indicate, but is not limited to, a software and/or hardware component, such as a field programmable gate array (FPGA) or an application specific integrated circuit (ASIC), which performs certain tasks. A module may be configured to reside in a tangible addressable storage medium and be configured to execute on one or more processors. For example, a “module” may include components such as software components, object-oriented software components, class components and task components, and processes, functions, Routines, segments of program code, drivers, firmware, microcode, circuitry, data, databases, data structures, tables, arrays, and variables. A “module” may be divided into a plurality of “modules” that perform detailed functions.

In some example embodiments, the system 1000 may be a computing system. In some example embodiments, the system 1000 may be provided as a dedicated system for the method of training the deep learning model for optical proximity correction and/or an optical proximity correction method according to some example embodiments, and may be referred to as an optical proximity correction system (or layout correction system). In some example embodiments, the system 1000 may be provided as a dedicated system for a method of designing a semiconductor device using the method of training the deep learning model for optical proximity correction and/or the optical proximity correction method according to example embodiments, and may be referred to as a semiconductor design system. For example, the system 1000 may include various design programs, verification programs and/or simulation programs.

The processor 1100 may control an operation of the system 1000, and may be utilized when the optical proximity correction module 1300 performs computations or calculations. For example, the processor 1100 may include a micro-processor, an application processor (AP), a central processing unit (CPU), a digital signal processor (DSP), a graphic processing unit (GPU), a neural processing unit (NPU), or the like. Although FIG. 2 illustrates that the system 1000 includes one processor 1100, example embodiments are not limited thereto. For example, the system 1000 may include a plurality of processors. In addition, the processor 1100 may include cache memories to increase computation capacity.

The storage device 1200 may store data used for the operation of the system 1000 and/or an operation of the optical proximity correction module 1300. For example, the storage device 1200 may store a deep learning model (or data related to the deep learning model) DLM, a plurality of data DAT, and design rules (or data related to the design rules) DR. For example, the plurality of data DAT may include sample data, simulation data, real data, and various other data. The real data may also be referred to herein as actual data or measured data from the manufactured semiconductor device and/or manufacturing process. The deep learning model DLM and the design rules DR may be provided to the optical proximity correction module 1300 from the storage device 1200.

In some example embodiments, the storage device (or storage medium) 1200 may include any non-transitory computer-readable storage medium used to provide commands and/or data to a computer. For example, the non-transitory computer-readable storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), or the like. The non-transitory computer-readable storage medium may be inserted into the computer, may be integrated in the computer, or may be coupled to the computer through a communication medium such as a network and/or a wireless link.

The optical proximity correction module 1300 may generate, obtain or form an output layout LY_OUT based on (e.g., by correcting or compensating) an input layout LY_IN. The optical proximity correction module 1300 may include a deep learning module 1310, a training module 1320 and a determination module 1330.

The optical proximity correction module 1300 may perform the method of training the deep learning model for optical proximity correction according to example embodiments described with reference to FIG. 1.

For example, the deep learning module 1310 and the training module 1320 may receive the input layout LY_IN. The deep learning module 1310 may execute the deep learning model DLM based on the input layout LY_IN, and the training module 1320 may perform a training operation on the deep learning model DLM based on the input layout LY_IN. The determination module 1330 may receive and verify a result of the training operation on the deep learning model DLM, and may obtain and provide the output layout LY_OUT based on a result of the verifying operation. In this example, the deep learning model DLM may be the deep learning model that is a target of the training operation of FIG. 1, the input layout LY_IN may include the sample input images and the sample reference images used in the training operation of FIG. 1, and the output layout LY_OUT may include the result of the training operation of FIG. 1. In other words, the deep learning module 1310 and the training module 1320 may perform operations S100 and S200 in FIG. 1, and the deep learning module 1310, the training module 1320 and the determination module 1330 may perform operation S300 in FIG. 1.

In addition, the optical proximity correction module 1300 may perform the optical proximity correction method according to some example embodiments, which will be described with reference to FIG. 9.

For example, the deep learning module 1310 may receive the input layout LY_IN, and may obtain an optical proximity correction model associated with the input layout LY_IN based on or using the deep learning model DLM. The determination module 1330 may receive and verify the optical proximity correction model obtained using the deep learning model DLM, and may obtain and provide the output layout LY_OUT based on a result of the verifying operation. In this example, the deep learning model DLM may be the deep learning model that is used in the optical proximity correction method of FIG. 9 and trained by the method of FIG. 1, the input layout LY_IN may be a target of the optical proximity correction method of FIG. 9 and may correspond to the design layout including the layout patterns, and the output layout LY_OUT may correspond to a corrected design layout of FIG. 9 including corrected layout patterns corresponding to the layout patterns. In other words, the deep learning module 1310 may perform operations S1100 and S1200 in FIG. 9, and the determination module 1330 may perform operations S1200 and S1300 in FIG. 9.

In some example embodiments, the optical proximity correction module 1300 may be implemented as instructions or program code that may be executed by the processor 1100. For example, the instructions or program code of the deep learning module 1310, the training module 1320 and the determination module 1330 that are included in the optical proximity correction module 1300 may be stored in computer readable medium. For example, the processor 1100 may load the instructions or program code to a working memory (e.g., a DRAM, etc.).

In other example embodiments, the processor 1100 may be manufactured to execute (e.g., efficiently execute) instructions or program code included in the optical proximity correction module 1300. For example, the processor 1100 may execute (e.g., efficiently execute) the instructions or program code of the deep learning module 1310, the training module 1320 and the determination module 1330 that are included in the optical proximity correction module 1300. For example, the processor 1100 may receive information corresponding to the deep learning module 1310, the training module 1320 and the determination module 1330 to operate the deep learning module 1310, the training module 1320 and the determination module 1330.

In some example embodiments, the deep learning module 1310, the training module 1320 and the determination module 1330 may be implemented as a single integrated module. In other example embodiments, the deep learning module 1310, the training module 1320 and the determination module 1330 may be implemented as separate and different modules.

Referring to FIG. 3, a system 2000 may include a processor 2100, an input/output (I/O) device 2200, a network interface 2300, a random access memory (RAM) 2400, a read only memory (ROM) 2500 and/or a storage device 2600. FIG. 3 illustrates an example where all of components of the optical proximity correction module 1300 in FIG. 2 are implemented in software.

The system 2000 may be a computing system. For example, the computing system may be a fixed computing system such as a desktop computer, a workstation or a server, or may be a portable computing system such as a laptop computer.

The processor 2100 may be substantially the same as the processor 1100 in FIG. 2. For example, the processor 2100 may include a core or a processor core for executing an arbitrary instruction set (for example, intel architecture-32 (IA-32), 64 bit extension IA-32, x86-64, PowerPC, Sparc, MIPS, ARM, IA-64, etc.). For example, the processor 2100 may access a memory (e.g., the RAM 2400 or the ROM 2500) through a bus, and may execute instructions stored in the RAM 2400 or the ROM 2500. As illustrated in FIG. 3, the RAM 2400 may store a program PR corresponding to the optical proximity correction module 1300 in FIG. 2 or at least some elements of the program PR, and the program PR may allow the processor 2100 to perform operations for training the deep learning model (e.g., operations S100, S200 and S300 in FIG. 1) and/or operations for the optical proximity correction (e.g., operations S1100, S1200 and S1300 in FIG. 9) in the semiconductor designing phase.

In other words, the program PR may include a plurality of instructions and/or procedures executable by the processor 2100, and the plurality of instructions and/or procedures included in the program PR may allow the processor 2100 to perform the operations for training the deep learning model and/or the operations for the optical proximity correction in the semiconductor designing phase according to some example embodiments. Each of the procedures may denote a series of instructions for performing a certain task. A procedure may be referred to as a function, a routine, a subroutine, or a subprogram. Each of the procedures may process data provided from the outside and/or data generated by another procedure.

In some example embodiments, the RAM 2400 may include any volatile memory such as an SRAM, a DRAM, or the like.

The storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or the like or at least some elements of the program PR may be loaded to the RAM 2400.

The storage device 2600 may store data, which is to be processed by the processor 2100, or data obtained through processing by the processor 2100. The processor 2100 may process the data stored in the storage device 2600 to generate new data, based on the program PR and may store the generated data in the storage device 2600.

The I/O device 2200 may include an input device, such as a keyboard, a pointing device, or the like, and may include an output device such as a display device, a printer, or the like. For example, a user may trigger, through the I/O devices 2200, execution of the program PR by the processor 2100, and may provide or check various inputs, outputs and/or data, etc.

The network interface 2300 may provide access to a network outside the system 2000. For example, the network may include a plurality of computing systems and communication links, and the communication links may include wired links, optical links, wireless links, or arbitrary other type links. Various inputs may be provided to the system 2000 through the network interface 2300, and various outputs may be provided to another computing system through the network interface 2300.

In some example embodiments, the computer program code and/or the optical proximity correction module 1300 may be stored in a transitory or non-transitory computer readable medium. In some example embodiments, values resulting from the training and/or optical proximity correction performed by the processor or values obtained from arithmetic processing performed by the processor may be stored in a transitory or non-transitory computer readable medium. In some example embodiments, intermediate values during the training and/or optical proximity correction and/or various data generated by the training and/or optical proximity correction may be stored in a transitory or non-transitory computer readable medium. However, the present inventive concepts and example embodiments thereof are not limited thereto.

FIGS. 4A, 4B, 4C, 4D, 4E, 5A, 5B and 5C are diagrams for describing a deep learning model used in a method of training a deep learning model for optical proximity correction and/or an optical proximity correction method according to some example embodiments.

Referring to FIGS. 2, 4A, 4B, 4C, 4D and 4E, the deep learning model DLM may be implemented as a generative adversarial network 1400. The generative adversarial network 1400 may include a generator model 1410 and a discriminator model 1420.

As best seen in FIG. 4A, the generator model 1410 may output sample prediction images SAM_PIMG based on sample input images SAM_IIMG. The discriminator model 1420 may output a discrimination value DV based on sample reference images SAM_RIMG and the sample prediction images SAM_PIMG such that the discrimination value DV indicates a similarity between the sample reference images SAM_RIMG and the sample prediction images SAM_PIMG.

In some example embodiments, the discrimination value DV may approach zero as the sample prediction images SAM_PIMG further deviate from (or are further different from) the sample reference images SAM_RIMG. The discrimination value DV may approach one as the sample prediction images SAM_PIMG further approach to (or are further similar to) the sample reference images SAM_RIMG. In some example embodiments, the deep learning model DLM may be trained, e.g., the training of the generative adversarial network 1400 may be controlled, such that the discrimination value DV approaches 0.5.

The generative adversarial network 1400 may predict a probability distribution of original data. In general, the generative adversarial network 1400 may include the discriminator model 1420 for discrimination and the generator model 1410 for regression generation. The generator model 1410 and the discriminator model 1420 may contend mutually to improve performance of an opponent. As the competition is progressed, the generator model 1410 may generate fake data that is not distinguishable from true data, and the generative adversarial network 1400 may generate the probability distribution that is substantially the same as the probability distribution of the original data. For example, the discrimination value DV generated by the discriminator model 1420 may approach 0.5, which indicates that further discrimination would be meaningless and/or ineffective.

The training or learning of the discriminator model 1420 may include two processes. The first process may be to input the true data to the discriminator model 1420 and train the discriminator model 1420 to determine the input data as the true data, and the second process may be to input the fake data to the discriminator model 1420 and train the discriminator model 1420 to determine the input data as the fake data. Through the two processes, the discriminator model 1420 may be trained to discriminate the true data and the fake data.

The performance of both of the discriminator model 1420 and the generator model 1410 may be enhanced through the mutual contest. As a result, the generator model 1410 may generate the perfect fake data and the discriminator model 1420 cannot distinguish the fake data from the true data.

For example, the generative adversarial network 1400 may be trained to solve the following problem or equation using an object function V(D, G).

$${min}_{G} {max}_{D} V ( D , G ) = {E}_{x ∼ {p}_{data} ( x )} [ log D ( x ) ] + {E}_{z ∼ {p}_{z} ( z )} [ log ( 1 - D ( G ( z ) ) ] \qquad [ Equation 1 ]$$

In Equation 1, x˜Pdata(x) denotes sampled data from the probability distribution of the real data, and z˜Pz(z) denotes sampled data from arbitrary noise using a general Gaussian distribution. “z” is referred to as a latent vector that is a vector in a reduced dimension to describe the data conveniently. The discrimination value D(x) is between zero and one. The discrimination value D(x) is one when the data x is true, and the discrimination value D(x) is zero when the data x is fake. The discrimination value D(G(z)) is one when the discriminator model 1420 determines that the data G(z) generated by the generator model 1410 is true, and the discrimination value D(G(z)) is zero when the discriminator model 1420 determines that the data G(z) is fake.

To maximize the object function V(D, G) by the discriminator model 1420, both of the first item and the second item in Equation 1 are maximized (and/or increased), that is, both of log D(x) and log(1-D(G(z))) have to be maximized (and/or increased). Accordingly, in some example embodiments, D(x) has to be one, which indicates that the discriminator model 1420 is trained to determine the real data as the true data. For example, training the generative adversarial network 1400 to maximize the object function V(D, G) indicates training the discriminator model 1420 to determine the true data as the true data and the fake data as the fake data.

To minimize the object function V(D, G) by the generator model 1410, the second item (e.g., log(1-D(G(z)))) is minimized such that the first item is irrelevant to the generator model 1410. Accordingly, in some example embodiments, log(1-D(G(z))) is zero and D(G(z)) is one, which indicates training the generator model 1410 to generate the perfect fake data that cannot be discriminated by the discriminator model 1420.

As such, training the discriminator model 1420 to maximize the object function V(D, G) and the generator model 1410 to minimize the object model V(D, G) may be referred to as a “minmax” problem.

FIGS. 4B, 4C, 4D and 4E illustrate the above-described operations of the generator model 1410 and the discriminator model 1420. In FIGS. 4B, 4C, 4D and 4E, dashed line “DC_DIST” denotes the distribution of the discrimination by the discriminator model 1420, solid line “GN_DIST” denotes the distribution of the fake data by the generator model 1410, and dotted line “DAT_DIST” denotes the probability distribution of the original data. FIG. 4B illustrates an initial status before the training process, FIGS. 4C and 4D illustrate changes in distributions as the training process is performed, and FIG. 4E illustrate a final status in which the probability distribution finally generated by the generative adversarial network 1400 is almost identical to the probability distribution of the original data and the discriminator model 1420 cannot distinguish the fake data from the true data.

Referring to FIGS. 5A, 5B and 5C, the generator model 1410 and the discriminator model 1420 included in the generative adversarial network 1400 may be implemented based on a neural network.

In FIG. 5A, an example of a general neural network (or artificial neural network) is illustrated. The general neural network may include an input layer IL, a plurality of hidden layers HL1, HL2, . . . , HLn and an output layer OL.

The input layer IL may include i input nodes x₁, x₂, . . . , xᵢ, where i is a natural number. Input data (e.g., vector input data) IDAT whose length is i may be input to the input nodes x₁, x₂, . . . , xᵢ such that each element of the input data IDAT is input to a respective one of the input nodes x₁, x₂, . . . , xᵢ. The input data IDAT may include information associated with the various features of the different classes to be categorized.

The plurality of hidden layers HL1, HL2, . . . , HLn may include n hidden layers, where n is a natural number, and may include a plurality of hidden nodes h¹₁, h¹₂, h¹₃, . . . , h¹ₘ, h²₁, h²₂, h²₃, . . . , h²ₘ, hⁿ₁, hⁿ₂, hⁿ₃, . . . , hⁿₘ. For example, the hidden layer HL1 may include m hidden nodes h¹₁, h¹₂, h¹₃, . . . , h¹ₘ, the hidden layer HL2 may include m hidden nodes h²₁, h²₂, h²₃, . . . h²ₘ, and the hidden layer HLn may include m hidden nodes hⁿ₁, hⁿ₂, hⁿ₃, . . . , hⁿₘ, where m is a natural number.

The output layer OL may include j output nodes y₁, y₂, . . . yⱼ, where j is a natural number. Each of the output nodes y₁, y₂, . . . , yⱼ may correspond to a respective one of classes to be categorized. The output layer OL may generate output values (e.g., class scores or numerical output such as a regression variable) and/or output data ODAT associated with the input data IDAT for each of the classes. In some example embodiments, the output layer OL may be a fully-connected layer and may indicate, for example, a probability that the input data IDAT corresponds to a car.

A structure of the neural network illustrated in FIG. 5A may be represented by information on branches (or connections) between nodes illustrated as lines, and a weighted value assigned to each branch, which is not illustrated. In some neural network models, nodes within one layer may not be connected to one another, but nodes of different layers may be fully or partially connected to one another. In some other neural network models, such as unrestricted Boltzmann machines, at least some nodes within one layer may also be connected to other nodes within one layer in addition to (or alternatively with) one or more nodes of other layers.

Each node (e.g., the node h¹₁) may receive an output of a previous node (e.g., the node x₁), may perform a computing operation, computation or calculation on the received output, and may output a result of the computing operation, computation or calculation as an output to a next node (e.g., the node h²₁). Each node may calculate a value to be output by applying the input to a specific function, e.g., a nonlinear function. This function may be called the activation function for the node.

In some example embodiments, the structure of the neural network may be set in advance, and the weighted values for the connections between the nodes are set appropriately by using sample data having sample answer (also referred to as a “label”), which indicates a class the data corresponding to a sample input value. The data with the sample answer may be referred to as “training data”, and a process of determining the weighted values may be referred to as “training”. The neural network “learns” to associate the data with corresponding labels during the training process. A group of an independently trainable neural network structure and the weighted values that have been trained using an algorithm may be referred to as a “model”, and a process of predicting, by the model with the determined weighted values, which class new input data belongs to, and then outputting the predicted value, may be referred to as a “testing” process or operating the neural network in inference mode.

In FIG. 5B, an example of an operation (e.g., computation or calculation) performed by one node ND included in the neural network of FIG. 5A is illustrated in detail.

Based on N inputs a₁, a₂, a₃, . . . , a_{N} provided to the node ND, where N is a natural number greater than or equal to two, the node ND may multiply the N inputs a₁ to a_{N} and corresponding N weights w₁, w₂, w₃, . . . w_{N}, respectively, may sum N values obtained by the multiplication, may add an offset “b” to a summed value, and may generate one output value (e.g., “z”) by applying a value to which the offset “b” is added to a specific function “σ”.

In some example embodiments and as illustrated in FIG. 5B, one layer included in the neural network illustrated in FIG. 5A may include M nodes ND, where M is a natural number greater than or equal to two, and output values of the one layer may be obtained by Equation 2.

W*A=Z [Equation 2]

In Equation 2, “W” denotes a weight set including weights for all connections included in the one layer, and may be implemented in an M*N matrix form. “A” denotes an input set including the N inputs a₁ to a_{N} received by the one layer, and may be implemented in an N*1 matrix form. “Z” denotes an output set including M outputs z₁, z₂, z₃, . . . , z_{M} output from the one layer, and may be implemented in an M*1 matrix form.

The general neural network illustrated in FIG. 5A may not be suitable for handling input image data (or input sound data) because each node (e.g., the node h¹₁) is connected to all nodes of a previous layer (e.g., the nodes x₁, x₂, . . . , xᵢ included in the layer IL) and then the number of weighted values drastically increases as the size of the input image data increases. Thus, a convolutional neural network (CNN), which is implemented by combining the filtering technique with the general neural network, has been researched such that a two-dimensional image, as an example of the input image data, is efficiently trained by the convolutional neural network.

In FIG. 5C, an example of a convolutional neural network is illustrated. The convolutional neural network may include a plurality of layers CONV1, RELU1, CONV2, RELU2, POOL1, CONV3, RELU3, CONV4, RELU4, POOL2, CONV5, RELU5, CONV6, RELU6, POOL3 and FC. Here, “CONN” denotes a convolutional layer, “RELU” denotes a rectified linear unit layer or activation function, “POOL” denotes a pooling layer, and “FC” denotes a fully-connected layer.

Unlike the general neural network, each layer of the convolutional neural network may have three dimensions of a width, a height and a depth, and thus data that is input to each layer may be volume data having three dimensions of a width, a height and a depth. For example, if an input image in FIG. 5C has a size of 32 widths (e.g., 32 pixels) and 32 heights and three color channels R, G and B, input data IDAT corresponding to the input image may have a size of 32*32*3. The input data IDAT in FIG. 5C may be referred to as input volume data or input activation volume.

Each of the convolutional layers CONV1, CONV2, CONV3, CONV4, CONV5 and CONV6 may perform a convolutional operation on input volume data. In an image processing operation, the convolutional operation represents an operation in which image data is processed based on a mask with weighted values and an output value is obtained by multiplying input values by the weighted values and adding up the total multiplication results. The mask may be referred to as a filter, a window, or a kernel.

Parameters of each convolutional layer may include a set of learnable filters. Every filter may be small spatially (along a width and a height), but may extend through the full depth of an input volume. For example, during a forward pass, each filter may be slid (e.g., convolved) across the width and height of the input volume, and dot products may be computed between the entries of the filter and the input at any position. As the filter is slid over the width and height of the input volume, a two-dimensional activation map corresponding to responses of that filter at every spatial position may be generated. As a result, an output volume may be generated by stacking these activation maps along the depth dimension. For example, if input volume data having a size of 32*32*3 passes through the convolutional layer CONV1 having four filters with zero-padding, output volume data of the convolutional layer CONV1 may have a size of 32*32*12 (e.g., a depth of volume data increases).

Each of the RELU layers RELU1, RELU2, RELU3, RELU4, RELU5 and RELU6 may perform a rectified linear unit (RELU) operation that corresponds to an activation function defined by, e.g., a function f(x)=max(0, x) (e.g., an output is zero for all negative input x). For example, if input volume data having a size of 32*32*12 passes through the RELU layer RELU1 to perform the rectified linear unit operation, output volume data of the RELU layer RELU1 may have a size of 32*32*12 (e.g., a size of volume data is maintained).

Each of the pooling layers POOL1, POOL2 and POOL3 may perform a down-sampling operation on input volume data along spatial dimensions of width and height. For example, four input values arranged in a 2*2 matrix formation may be converted into one output value based on a 2*2 filter. For example, a maximum value of four input values arranged in a 2*2 matrix formation may be selected based on 2*2 maximum pooling, or an average value of four input values arranged in a 2*2 matrix formation may be obtained based on 2*2 average pooling. For example, if input volume data having a size of 32*32*12 passes through the pooling layer POOL1 having a 2*2 filter, output volume data of the pooling layer POOL1 may have a size of 16*16*12 (e.g., a width and a height of volume data decreases, and a depth of volume data is maintained).

Typically, convolutional layers may be repeatedly arranged in the convolutional neural network, and the pooling layer may be periodically inserted in the convolutional neural network, thereby reducing a spatial size of an image and extracting a characteristic of the image.

The output layer or fully-connected layer FC may output results (e.g., class scores) of the input volume data IDAT for each of the classes. For example, the input volume data IDAT corresponding to the two-dimensional image may be converted into a one-dimensional matrix or vector, which may be referred to as an embedding, as the convolutional operation and the down-sampling operation are repeated. For example, the fully-connected layer FC may indicate probabilities that the input volume data IDAT corresponds to a car, a truck, an airplane, a ship and a horse.

The types and number of layers included in the convolutional neural network may not be limited to an example described with reference to FIG. 5C and may be variously determined according to example embodiments. In addition, although not illustrated in FIG. 5C, the convolutional neural network may further include other layers such as a softmax layer for converting score values corresponding to predicted results into probability values, a bias adding layer for adding at least one bias, or the like. The bias may also be incorporated into the activation function.

However, example embodiments may not be limited to the above-described neural networks. For example, the generator model 1410 and the discriminator model 1420 included in the generative adversarial network 1400 m may be implemented based on various other neural networks such as region with convolutional neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzman machine (RBM), fully-convolutional network, long short-term memory (LSTM) network, and/or the like. Alternatively or additionally, the neural network may include other forms of machine learning models, such as, for example, linear and/or logistic regression, statistical clustering, Bayesian classification, decision trees, dimensionality reduction such as principal component analysis, and expert systems; and/or combinations thereof, including ensembles such as random forests.

FIG. 6 is a flowchart illustrating an example of performing a training operation in FIG. 1.

Referring to FIGS. 1 and 6, when performing the training operation on the deep learning model (operation S300), sample prediction images may be output by executing the deep learning model based on the sample input images (operation S310), and the deep learning model may be trained based on the sample reference images and the sample prediction images (operation S320).

For example, a forward propagation and a backpropagation may be performed on the deep learning model. The forward propagation may be a portion of procedures while the training operation is performed, and the backpropagation may be another portion of procedures performed while the training operation is performed. The forward propagation may represent a process of calculating output (or output data) by passing input (or input data) through the deep learning model in a forward direction. The backpropagation may represent a process of calculating loss by comparing the output with a label, which is ground truth obtained in advance, a process of calculating a gradient for the weights such that the loss is reduced by passing the calculated loss through the deep learning model in a reverse direction, and a process of updating the weights. The backpropagation may be referred to as an error backpropagation.

For example, while the deep learning model is trained, the sample prediction images may be generated by applying the sample input images to the deep learning model (e.g., by providing the sample input images as inputs to the deep learning model and by sequentially performing a plurality of computing operations on the sample input images), and a consistency of the deep learning model may be checked by comparing the sample reference images with the sample prediction images. For example, the sample reference images may represent ground truth (or correct answer information) associated with the sample input images, and the sample prediction images may represent outputs of the deep learning model when the sample input images are provided as inputs to the deep learning model. For example, as or when the deep learning model is trained, a plurality of weights included in the deep learning model may be updated.

FIGS. 7A, 7B, 7C and 7D are diagrams for describing an operation of FIG. 6.

Referring to FIG. 7A, an example of a sample input image SAM_IIMG1 associated with the sample layout is illustrated. For example, the sample layout may include rectangular patterns in which vias may be formed. In other words, the sample layout may be a layout to form the vias. For example, the sample layout may specify a target layout required to be obtained in the after-development inspection, e.g., a layout including photoresist patterns.

Referring to FIG. 7B, an example of a sample reference image SAM_RIMG1 extracted from the sample mask is illustrated. For example, the sample mask may include patterns that are modified from the rectangular patterns in FIG. 7A, e.g., patterns to which the corner rounding operation is applied to or performed on the rectangular patterns. For example, the sample mask may be a photomask that is obtained by performing the optical proximity correction on the sample layout and by fabricating based on a result of the optical proximity correction on the sample layout.

Referring to FIG. 7C, an example of a sample prediction image SAM_PIMG1, which is output from the deep learning model by applying the sample input image SAM_IIMG1 of FIG. 7A as an input to the deep learning model, is illustrated. For example, the sample prediction image SAM_PIMG1 may correspond to a corrected layout expected to be obtained by performing the optical proximity correction on the sample layout using the deep learning model.

The training operation may be performed on the deep learning model using the sample input image SAM_IIMG1, the sample reference image SAM_RIMG1 and the sample prediction image SAM_PIMG1. For example, the deep learning model may be trained such that the sample prediction image SAM_PIMG1 may be identical to or as close to identical as possible to the sample reference image SAM_RIMG1.

In some example embodiments, before the training operation is performed, an image processing operation may be performed on the sample input image SAM_IIMG1, the sample reference image SAM_RIMG1, and the sample prediction image SAM_PIMG1. For example, a dithering may be performed on at least one of the sample input image SAM_IIMG1, the sample reference image SAM_RIMG1 and the sample prediction image SAM_PIMG1, and the training operation may be performed based on the dithered image. For example, when magnifications of the images are different from each other, an image processing operation may be performed such that the magnifications of the images are equal to each other. For example, the training operation may be performed based on images obtained by zooming in or zooming out (e.g., increasing or decreasing a magnification) at least one of the sample input image SAM_IIMG1, the sample reference image SAM_RIMG1 and the sample prediction image SAM_PIMG1 with a plurality of scaling factors (or magnification factors).

Referring to FIG. 7D, an example of the sample layout patterns included in the sample layout and/or the sample mask patterns included in the sample mask is illustrated.

In some example embodiments, the sample input images and the sample reference images may include only images of corner portions CNR of the sample layout patterns and the sample mask patterns. As described above, since the deep learning is implemented to perform the corner rounding operation, only the images of the corner portions CNR may be used to train the deep learning model.

In other example embodiments, the sample input images and the sample reference images may include the images of the corner portions CNR and images of edge (or side) portions (or simply edges or sides) EDG of the sample layout patterns and the sample mask patterns. For example, the number (or quantity) of the images of the corner portions CNR may be greater than the number of the images of the edge portions EDG.

As described above, the deep learning model may be trained using only the images of the corner portions CNR or using more the images of the corner portions CNR, e.g., by assigning a higher weight (or importance) to the images of the corner portions CNR.

FIG. 8 is a flowchart illustrating an example of performing a training operation in FIG. 1. The descriptions repeated with FIG. 6 will be omitted for brevity.

Referring to FIGS. 1 and 8, when performing the training operation on the deep learning model (operation S300), operations S310 and S320 may be substantially the same as those described with reference to FIG. 6.

Thereafter, a verifying operation may be performed on the trained deep learning model. For example, an error value of the trained deep learning model may be calculated based on the sample reference images and the sample prediction images (operation S330), and the error value may be compared with a reference value (operation S340).

When the error value of the trained deep learning model is greater than the reference value (YES branch from operation S340), e.g., when a consistency of the deep learning model does not reach or is lower than a target consistency, the deep learning model may be re-trained (operation S350). Operation S350 may be similar to operation S320. For example, additional sample input images, additional sample reference images and additional sample prediction images may be further obtained, the deep learning model may be trained again using the additionally obtained images, and the verifying operation of S330 and S340 may be performed again.

When the error value of the trained deep learning model is less than or equal to the reference value (NO branch from operation S340), e.g., when the consistency of the deep learning model reaches or is higher than the target consistency, a result of the training operation (e.g., finally updated weights) may be stored, and the training operation may be terminated.

According to some example embodiments, the deep learning model that may be used is trained based on the images of masks that are actually fabricated, and thus the corner rounding operation may be performed on or applied to the masks and/or the mask patterns accurately and efficiently. In addition, images of various masks and patterns may be accumulated for each process, the deep learning model may be continuously trained and updated based on the accumulated images, and thus the utilization of the deep learning models may increase. Further, the patterning limit depending on the corner rounding operation resulting from each process may be checked and may be reflected in the deep learning model. Accordingly, the accuracy of the corner rounding operation may be improved or enhanced, the accuracy of the optical proximity correction may be improved or enhanced, and the process margin may also be improved or enhanced.

FIG. 9 is a flowchart illustrating an optical proximity correction method according to some example embodiments.

Referring to FIG. 9, an optical proximity correction method according to some example embodiments may be performed in a semiconductor designing/manufacturing phase or during a designing/manufacturing procedure of a semiconductor device. For example, the optical proximity correction method according to example embodiments may be performed by a system and/or a tool for optical proximity correction and/or semiconductor design. For example, the system may be implemented as described with reference to FIGS. 2 and 3.

In the optical proximity correction method according to some example embodiments, a design layout including layout patterns for semiconductor process to form process patterns of a semiconductor device may be received (operation S1100). For example, the design layout may be provided in the form of data having graphic design system (GDS) format or in the form of an image having NGR format obtained from equipments by Nano Geometry Research (NGR) Inc. However, example embodiments are not limited thereto, and the design layout may have various other data and/or image formats.

An optical proximity correction model associated with the design layout may be obtained based on a deep learning model used in optical proximity correction (operation S1200). A corrected design layout including corrected layout patterns corresponding to the layout patterns may be obtained based on the optical proximity correction model (operation S1300).

The deep learning model may be trained by the method of training the deep learning model for optical proximity correction according to example embodiments described with reference to FIGS. 1, 2, 3, 4A, 4B, 4C, 4D, 4E, 5A, 5B, 5C, 6, 7A, 7B, 7C, 7D and 8, and may be implemented to perform the corner rounding operation. For example, the deep learning model may perform the corner rounding operation on the corner portions of the sample layout patterns included in the sample layouts used in the training operation. For example, the deep learning model may perform the corner rounding operation on corner portions of the layout patterns included in the design layout, which is a target of real optical proximity correction

A resolution enhancement technology may be used for preventing the distortion of layouts or patterns. The optical proximity correction may be an example of the resolution enhancement technology. The plurality of layout patterns that are included in the design layout and obtained by the layout design process may be implemented or realized on a silicon substrate by a photolithography process. The optical proximity correction may be performed to correct an optical proximity effect that may occur in the photolithography process. The optical proximity effect may be an unintended optical effect (e.g., refraction or diffraction) which may occur in the photolithography process. For example, a distortion phenomenon of layout patterns, which may be caused by the optical proximity effect, may be corrected by the optical proximity correction. The designed shapes and positions of the designed layout patterns may be slightly changed or biased by the optical proximity correction.

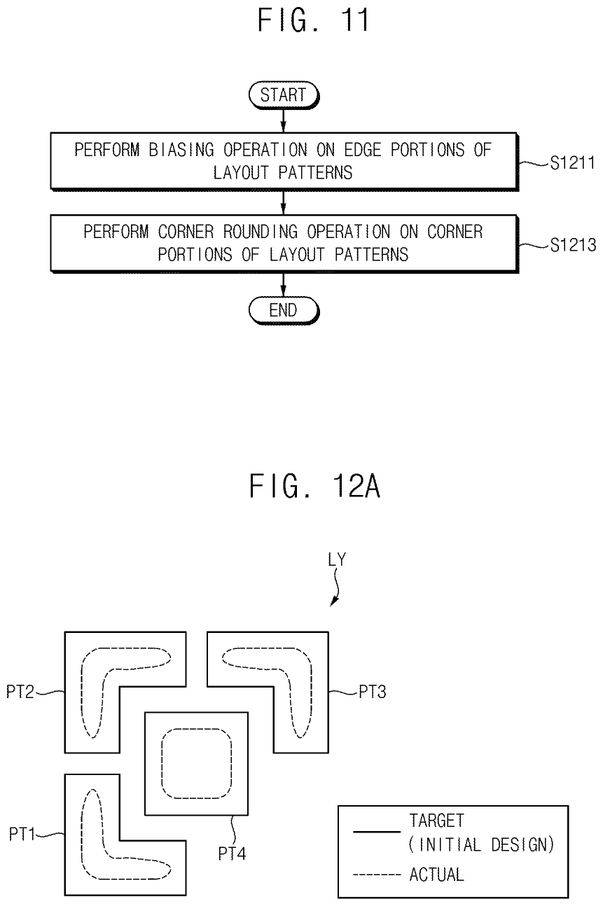

FIG. 10 is a flowchart illustrating an example of obtaining an optical proximity correction model in FIG. 9. FIG. 11 is a flowchart illustrating an example of generating an optical proximity correction model in FIG. 10. More specifically, FIG. 11 is a flowchart illustrating suboperations or operations that of generating the optical proximity correction model in operations S1210 of FIG. 10.

Referring to FIGS. 9, 10 and 11, when obtaining the optical proximity correction model associated with the design layout (operation S1200), the optical proximity correction model may be generated using the deep learning model (operation S1210). For example, a biasing operation may be performed on edge portions of the layout patterns (operation S1211), and the corner rounding operation may be performed on the corner portions of the layout patterns based on the deep learning model (operation S1213). The biasing operation and the corner rounding operation will be described with reference to FIGS. 12A, 12B, 12C and 12D.

An optical proximity effect (OPE) may occur due to effects between neighboring fine patterns during an exposure process, and the optical proximity correction may be a manner of overcoming the optical proximity effect, in which method a pattern layout is corrected to suppress the occurrence of the optical proximity effect. The optical proximity correction may be broadly classified into two types, a rule-based optical proximity correction and a simulation-based or model-based optical proximity correction. The model-based optical proximity correction may be applied or employed to the optical proximity correction method according to example embodiments.

To generate the optical proximity correction model, basic data for the optical proximity correction may be prepared first. For example, the basic data may include data about pattern shapes of a sample, positions of patterns, kinds of measurement such as measurement for space or line of patterns, basic measurement values, or the like. In addition, the basic data may include information about a thickness, a refractive index, and a dielectric constant of photoresist, and also include a source map about shapes of illumination system. However, the basic data is not limited to those data examples discussed above.

After the basic data is prepared, a first optical proximity correction model may be generated. The first optical proximity correction model may be referred to as an optical OPC model. For example, the generation of the first optical proximity correction model may include optimization of a defocus start (DS) position and of a best focus (BF) position in an exposure process. In addition, the generation of the first optical proximity correction model may include production of an optical image in consideration of diffraction of light or optical states of exposure equipment. However, the generation of the first optical proximity correction model is not limited thereto. For example, the generation of the first optical proximity correction model may include various contents related to optical phenomena of the exposure process.

After the first optical proximity correction model is generated, a second optical proximity correction model may be generated. The second optical proximity correction model may be referred to as an OPC model for photoresist. For example, the generation of the second optical proximity correction model may include optimization of a threshold value of photoresist. For example, the threshold value of photoresist may represent a threshold value at which a chemical change occurs in an exposure process, and may be provided as, for example, intensity of exposure light. In addition, the generation of the second optical proximity correction model may include selection of an appropriate form from various photoresist model forms.

In general, the first optical proximity correction model and the second optical proximity correction model may be collectively called the optical proximity correction model. An optical proximity correction modeling, or a generation procedure for the optical proximity correction model of S1210, may thus be defined to include both a procedure for generating the first optical proximity correction model and a procedure for generating the second optical proximity correction model. Herein, unless otherwise noted below, the optical proximity correction model may be used as a concept for combination of the first optical proximity correction model and the second optical proximity correction model.

Thereafter, a verifying operation may be performed on the optical proximity correction model (operation S1220). For example, the verifying operation may be performed by an edge placement error (EPE) check or a root mean square (RMS) calculation for critical dimension (CD) error.

When the verifying operation is failed (YES branch from operation S1230), e.g., when the optical proximity correction model does not satisfy a predetermined criterion, at least a part of the optical proximity correction model may be changed (operation S1240). Operation S1240 may be similar to operation S1210. For example, at least a part of the generation procedure for the optical proximity correction model, e.g., at least a part of the procedure for generating the first optical proximity correction model and the procedure for generating the second optical proximity correction model, may be performed again, and then operations S1220 and S1230 may be performed again.

When the verifying operation is succeeded (NO branch from operation S1230), e.g., when the optical proximity correction model satisfies the predetermined criterion, the verification of the optical proximity correction model may be completed, and operation S1200 may be terminated.

In some example embodiments, although not illustrated in FIG. 10, after the optical proximity correction model is verified, a simulation operation may be performed using the verified optical proximity correction model. Design data of a photomask close to actual measurement may be obtained by the simulation using the optical proximity correction model. The design data of the photomask obtained by the simulation may then be transferred to a mask production team as mask tape-out (MTO) design data for photomask fabrication.

FIGS. 12A, 12B, 12C and 12D are diagrams for describing an optical proximity correction method according to some example embodiments.

Referring to FIG. 12A, a design layout LY may include a first circuit pattern PT1, a second circuit pattern PT2, a third circuit pattern PT3 and a fourth circuit pattern PT4. The first to fourth circuit patterns PT1 to PT4 may correspond to the above-described layout patterns. The number of circuit patterns PT1 to PT4 and a shape or form of the design layout LY in FIG. 12A is an example, and example embodiments are not limited thereto.

In some example embodiments, solid lines of the first to fourth circuit patterns PT1 to PT4 in FIG. 12A may be a desired layout and may show a layout to be printed or implemented onto a substrate. The desired layout may be an initial design layout. For example, solid lines in FIG. 12A may correspond to a target layout. The target layout may be an initial/original design layout. For example, a semiconductor designer may provide the target layout corresponding to the solid lines of the design layout LY for printing on the substrate (e.g., a wafer).

However, the photolithography process may cause distortion, e.g., optical interference and optical diffraction. When the photolithography process is performed with image patterns corresponding to the solid lines in FIG. 12A, the first to fourth circuit patterns PT1 to PT4 may be actually implemented or realized along dotted lines in FIG. 12A on the substrate due to the distortion. As illustrated in FIG. 12A, the dimensions and shapes of the image patterns actually printed on the substrate (as illustrated by the dotted lines) may be different from the dimensions and shapes that are desired or intended to be printed on the substrate (as illustrated by the solid lines). When a distorted layout corresponding to the dotted lines in FIG. 12A is printed on the substrate, a designed circuit may operate abnormally or in a manner different from its intended purpose.

The optical proximity correction may be performed to prevent the distortion of the implemented layout. In the optical proximity correction, the design layout may be biased or shifted to reduce an error between the real/implemented layout and the desired layout. For example, a design layout including biased/shifted patterns may reduce differences in shape and dimension between the desired layout and the real printed layout. The biasing/shifting may be performed based on predicted distortion caused by optical interference and optical diffraction. When the photolithography process is performed based on image patterns corresponding to the biased/shifted design layout, the implemented layout formed by the photolithography process may be substantially same as the initial design layout (e.g., the desired layout). In other words, the implemented layout formed with the biased/shifted design layout may have a smaller error (or within an acceptable threshold of differences) than the implemented layout formed with the initial design layout.

Referring to FIGS. 11, 12A and 12B, when performing the biasing operation of S1211, each layout pattern may be divided into a plurality of segments.

For example, as illustrated in FIG. 12B, a plurality of dissection points DP1, DP2, DP3, DP4, DP5, DP6, DP7 and DP8 may be set or allocated on a contour or edges of the first circuit pattern PT1 included in the design layout LY of FIG. 12A, and the contour of the first circuit pattern PT1 may be divided into a plurality of segments SEG1, SEG2, SEG3, SEG4, SEG5, SEG6, SEG7 and SEG8 based on the plurality of dissection points DP1 to DP8. For example, the segment SEG1 may be obtained based on the dissection points DP1 and DP8.

Referring to FIGS. 11, 12B and 12C, when performing the biasing operation of S1211, at least one of the plurality of segments SEG1 to SEG8 may be shifted or biased. For example, each of the plurality of segments SEG1 to SEG8 may be compensated to reduce distortion of the implemented layout.

Each of the plurality of segments SEG1 to SEG8 may be independently and/or differently shifted or biased. For example, one segment may be shifted or biased in a first direction (e.g., a positive direction, an outward direction) or a second direction (e.g., a negative direction, an inward direction), independently of other segments. As illustrated in FIG. 12C, the segments SEG1, SEG3, SEG5, SEG6 and SEG7 may be shifted or biased in the first direction (e.g., the outward direction) to obtain shifted segments SEG1′, SEG3′, SEG5′, SEG6′ and SEG7′, and the segments SEG2, SEG4 and SEG8 may be shifted or biased in the second direction (e.g., the inward direction) to obtain shifted segments SEG2′, SEG4′ and SEG8′. The biasing/shifting of the segments may include, for example, moving the outside edges corresponding to the segments SEG1 to SEG8 in one of the first direction or the second direction. Each of the plurality of segments SEG1 to SEG8 may be shifted or biased to reduce an error between a real/implemented layout and the desired layout. For example, a certain segment may not be biased or shifted in either of the first direction or the second direction.

In addition, when performing the corner rounding operation of S1213, corners of the shifted segments SEG1′, SEG3′ and SEG6′ may become rounded using the deep learning model.

Referring to FIGS. 11, 12C and 12D, the corrected design layout may be formed as described with reference to operation S1300, based on results of performing the biasing operation and the corner rounding operation.

For example, a first corrected circuit pattern PT1′ may be obtained by correcting the first circuit pattern PT1 included in the design layout LY of FIG. 12A. As described above, the contour of the first circuit pattern PT1 may be divided into the plurality of segments, one or more of the plurality of segments may be biased or shifted, corners of the segments may be rounded, and thus the first corrected circuit pattern PT1′ may be obtained. For example, the corrected design layout including the first corrected circuit pattern PT1′ may be obtained.

As illustrated in FIG. 12D, when an actual, real, or physical layout is printed on the substrate with the corrected design layout (e.g., updated layout) including the first corrected circuit pattern PT1′, the actual, real, or physical layout may be approximately same as the desired layout (e.g., the initial design layout), and thus an error between the actual, real, or physical layout and the desired layout may be reduced.

Although FIGS. 12B, 12C and 12D illustrate an example having the first circuit pattern PT1 and the first corrected circuit pattern PT1′ corresponding to the first circuit pattern PT1, the present disclosure and example embodiments thereof are not limited thereto. For example, second to fourth corrected circuit patterns corresponding to the second to fourth circuit patterns PT2 to PT4 may be obtained, and the corrected design layout including the second to fourth corrected patterns may be obtained, in a similar manner.

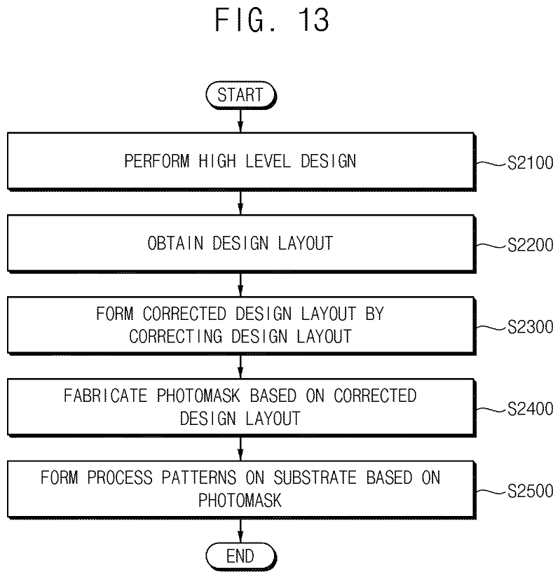

FIG. 13 is a flowchart illustrating a method of manufacturing a semiconductor device according to some example embodiments.

Referring to FIG. 13, in a method of manufacturing a semiconductor device according to some example embodiments, a high-level design process of the semiconductor device is performed (operation S2100). For example, in the high-level design process, an integrated circuit to be designed may be described in terms of high-level computer language (e.g., C language). Circuits designed by the high-level design process may be more concretely described by a register transfer level (RTL) coding or a simulation. In addition, codes generated by the RTL coding may be converted into a netlist, and the results may be combined with each other to realize an entire semiconductor device. The combined schematic circuit may be verified by a simulation tool. In some example embodiments, an adjusting operation may be further performed in consideration of a result of the verifying operation.

A design layout including layout patterns for semiconductor process to form process patterns of the semiconductor device is obtained (operation S2200). In other words, a layout design process may be performed to implement or realize a logically completed semiconductor device on a silicon substrate. For example, the layout design process may be performed based on the schematic circuit prepared in the high-level design process or the netlist corresponding thereto. The layout design process may include a routing operation of placing and connecting various standard cells that are provided from a cell library, based on a predetermined design rule.

A cell library for the layout design process may contain information on operation, speed, and power consumption of the standard cells. In some example embodiments, the cell library for representing a layout of a circuit having a specific gate level may be defined in a layout design tool (e.g., the system 1000 of FIG. 2). Here, the layout may be prepared to define or describe shapes and sizes of patterns constituting transistors and metal interconnection lines, which will be actually implemented or formed on a silicon substrate. For example, layout patterns (e.g., PMOS, NMOS, N-WELL, gate electrodes, and metal interconnection lines thereon) may be suitably disposed to actually form an inverter circuit on a silicon substrate. For this, at least one of inverters defined in the cell library may be selected.

In addition, the routing operation may be performed on selected and disposed standard cells. In greater detail, the routing operation may be performed on the selected and disposed standard cells to connect them to upper interconnection lines. By the routing operation, the standard cells may be electrically connected to each other to meet a design. These operations (e.g., operations S2100 and S2200) may be automatically or manually performed in the layout design tool. In some example embodiments, an operation of placing and routing the standard cells may be automatically performed by an additional place & routing tool.

After the routing operation, a verifying operation may be performed on the layout to check whether there is a portion violating the given design rule. In some example embodiments, the verifying operation may include evaluating verification items, such as a design rule check (DRC), an electrical rule check (ERC), and a layout vs schematic (LVS). The evaluating of the DRC item may be performed to evaluate whether the layout meets the given design rule. The evaluating of the ERC item may be performed to evaluate whether there is an issue of electrical disconnection in the layout. The evaluating of the LVS item may be performed to evaluate whether the layout is prepared to coincide with the gate-level netlist.

A corrected design layout is formed or generated by correcting the design layout (operation S2300). Operation S2300 may be performed by the optical proximity correction method according to example embodiments described with reference to FIGS. 9, 10, 11, 12A, 12B, 12C and 12D.

A photomask may be fabricated based on the corrected design layout (operation S2400). For example, the photomask may be fabricated or manufactured by patterning a chromium layer provided on a glass substrate, using the layout pattern data.

The process patterns are formed on a substrate using the photomask (operation S2500), and thus the semiconductor device is manufactured. For example, various exposure processes and etching processes may be repeated in the manufacture of the semiconductor device using the photomask. By these processes, shapes of patterns obtained in the layout design process may be sequentially formed on a silicon substrate.

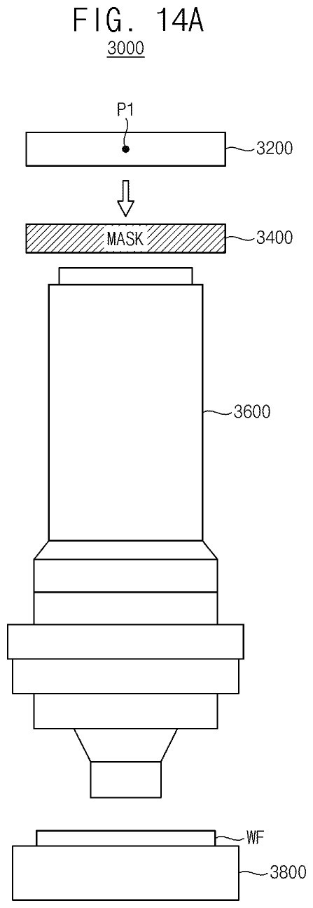

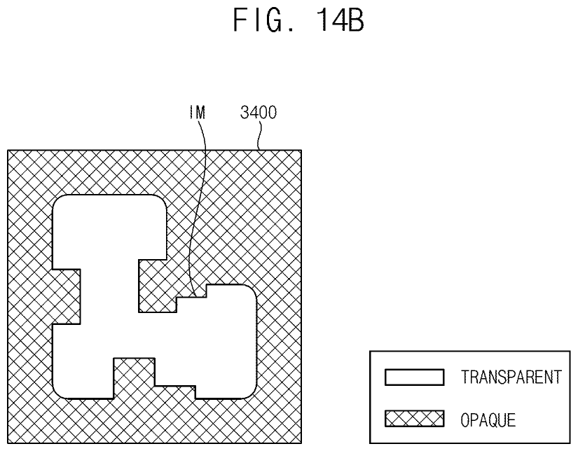

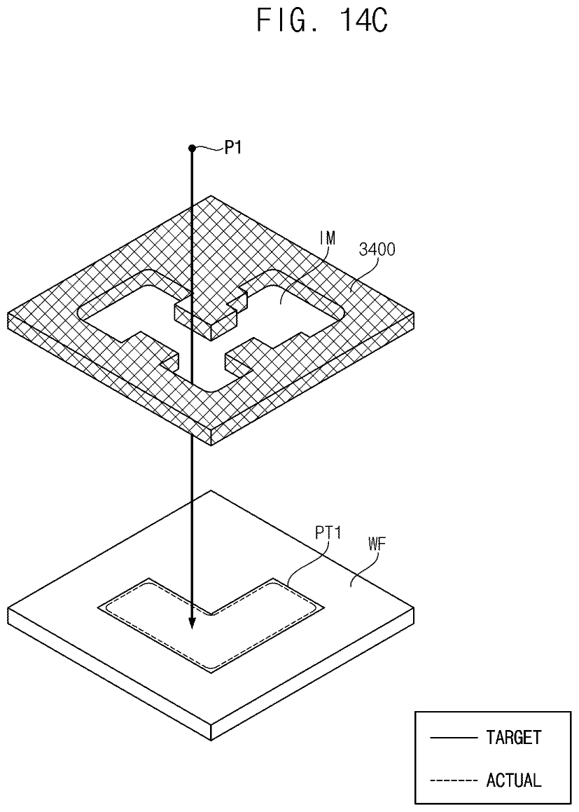

FIGS. 14A, 14B and 14C are diagrams for describing a method of manufacturing a semiconductor device according to some example embodiments.

Referring to FIG. 14A, a photolithography system 3000 that performs the method of manufacturing the semiconductor device of FIG. 13 may include a light source 3200, a photomask 3400, a reduction projection device 3600 and a substrate stage 3800.

The light source 3200 may emit light. The light emitted from the light source 3200 may be irradiated or provided to the photomask 3400. For example, a lens may be provided between the light source 3200 and the photomask 3400 to adjust a focus of light. For example, the light source 3200 may include one point light source P1, however, example embodiments are not limited thereto.

To print to realize a designed layout onto a substrate WF, the photomask 3400 may include image patterns. The image patterns may include one or more transparent regions and one or more opaque regions. The transparent regions may be formed of etching a metal layer (e.g., a chromium layer) on the photomask 3400. The transparent regions may transmit light emitted from the light source 3200. In some example embodiments, the opaque regions may not transmit light, and may block light.

The reduction projection device 3600 may receive light transmitted through the transparent regions of the photomask 3400. The reduction projection device 3600 may match layout patterns, to be printed onto the substrate WF, with the image patterns of the photomask 3400. The substrate stage 3800 may support the substrate WF. For example, the substrate stage 3800 may be a physical structure that holds the wafer WF in a desired position while the layout is printed on the substrate WF. In some example embodiments, the substrate WF may include a silicon wafer.

The reduction projection device 3600 may include an aperture, which is not illustrated in FIG. 14A. The aperture may be used to increase a depth of a focus of ultraviolet light emitted from the light source 3200. For example, the aperture may include a dipole aperture or a quadruple aperture. In some example embodiments, the reduction projection device 3600 may further include a lens for adjusting a focus of light.

The transparent regions in the image patterns of the photomask 3400 may transmit light emitted from the light source 3200. Light transmitted through the photomask 3400 may be irradiated to the substrate WF through the reduction projection device 3600. Thus, patterns corresponding to the image patterns of the photomask 3400 may be printed onto the substrate WF.

In some example embodiments, as an integration degree of a semiconductor device increases, the image patterns of the photomask 3400 become closer to each other and widths of the transparent regions become narrower. Due to this proximity between transparent regions, interference and diffraction of light may occur to print a distorted layout, different from a desired layout, onto the substrate WF. If the distorted layout is printed on the substrate WF, a designed circuit may operate abnormally.

The resolution enhancement technology may be used for preventing the distortion of the layout. The optical proximity correction is an example of a resolution enhancement technology. According to the optical proximity correction, a degree of the distortion, e.g., the interference and diffraction of light may be predicted. In addition, based on the predicted result, image patterns to be formed on the photomask 3400 may be biased or shifted in advance. Thus, a desired layout may be printed on the substrate WF.

In some example embodiments, the optical proximity correction may be performed to adjust or modify a single layer. In semiconductor manufacturing processes, a semiconductor device may be realized to include a plurality of layers. For example, a semiconductor device may include a plurality of layers that are stacked on one another (e.g., a plurality of stacked metal layers) to realize a specific circuit. Thus, in some example embodiments, the optical proximity correction may be independently performed on each of the plurality of layers.

Referring to FIG. 14B, the photomask 3400 may include an image pattern IM corresponding to the first corrected circuit pattern PT1′ in FIG. 12D. The photomask 3400 may include a transparent region and an opaque region. The opaque region may not transmit light, and may block light. In some example embodiments, the transparent region may transmit light emitted from the light source 3200 in FIG. 14A. Light transmitted through the photomask 3400 may be irradiated to a top surface of the substrate WF in FIG. 14A. The image pattern IM may form the transparent region.

Referring to FIG. 14C, when performing the photolithography process, the point light source P1 in the light source 3200 of FIG. 14A may emit light to the photomask 3400. The emitted light may pass through the transparent region of the image pattern IM and may be then irradiated to the substrate WF. Thus, the first circuit pattern PT1 corresponding to the image pattern IM may be printed onto the substrate WF.

When a real layout is printed on the substrate WF with the photomask 3400 including the image pattern IM, the real layout may be substantially same as the desired layout and may have a small error within an acceptable threshold. The desired layout is illustrated by a solid line and the real layout is illustrated by a dotted line in FIG. 14C. Thus, the optical proximity correction may be performed to fabricate the real layer with the photomask 3400 including the biased image patterns IM and to reduce the error between the real layout and the desired layout.

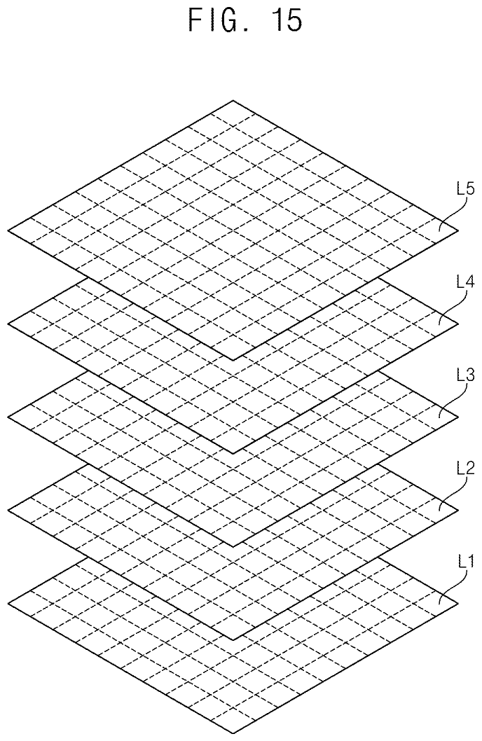

FIG. 15 is diagram illustrating an example of a layout of a semiconductor device manufactured by a method of manufacturing a semiconductor device according to some example embodiments.

Referring to FIG. 15, a layout of the semiconductor device may include a plurality of layout layers L1, L2, L3, L4 and L5. Each of the plurality of layout layers L1 to L5 may include various patterns for semiconductor circuits. For example, the layout of the semiconductor device may be a layout of a logic cell. The layout layer L1 may include a PMOS active pattern and an NMOS active pattern. The layout layer L2 may include gate patterns. The layout layer L3 may include active contact patterns and gate contact patterns. The layout layer L4 may include via patterns. The layout layer L5 may include interconnection patterns.

In some example embodiments, as illustrated in dotted lines in FIG. 15, each of the plurality of layout layers L1 to L5 may be divided into a plurality of patches. The optical proximity correction may be independently performed on each of the plurality of patches and may be independently performed on each of the plurality of layout layers L1 to L5.

The example embodiments may be applied to the designing and manufacturing processes of the semiconductor devices, and the semiconductor devices and/or systems obtained by the designing and manufacturing processes. For example, the example embodiments may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of training a deep learning model used in optical proximity correction to correct a layout pattern used in semiconductor device fabrication, the method comprising:
obtaining sample input images associated with sample layouts, wherein the sample layouts are targets of the optical proximity correction;
extracting sample reference images from sample masks that are fabricated by performing the optical proximity correction on the sample layouts, the sample reference images corresponding to the sample reference images; and
performing a training operation on the deep learning model used in the optical proximity correction based on the sample input images and the sample reference images,
wherein the sample layouts include sample layout patterns to form process patterns of a semiconductor device,
wherein the sample input images include images of corner portions of the sample layout patterns, and
wherein the deep learning model is used to perform a corner rounding operation on the corner portions of the sample layout patterns.

2. The method of claim 1, wherein performing the training operation includes:
outputting sample prediction images by executing the deep learning model based on the sample input images; and
training the deep learning model based on the sample reference images and the sample prediction images.

3. The method of claim 2, wherein, in response to training the deep learning model, weights included in the deep learning model are selected based on the corner rounding operation.

4. The method of claim 2, wherein performing the training operation further includes:
calculating an error value of the trained deep learning model based on the sample reference images and the sample prediction images; and
in response to the error value of the trained deep learning model being greater than a reference value, re-training the deep learning model.

5. The method of claim 4, wherein performing the training operation further includes:
in response to the error value of the trained deep learning model being smaller than or equal to the reference value, terminating the training operation.

6. The method of claim 2, wherein the deep learning model is a generative adversarial network (GAN).

7. The method of claim 6, wherein the deep learning model includes:
a generator model configured to output the sample prediction images based on the sample input images; and
a discriminator model configured to output a discrimination value based on the sample reference images and the sample prediction images such that the discrimination value indicates a similarity between the sample reference images and the sample prediction images.

8. The method of claim 7, wherein the generator model and the discriminator model are based on a convolutional neural network (CNN).

9. The method of claim 7,
wherein the discrimination value approaches zero as the sample prediction images increase in deviation from the sample reference images, and
wherein the discrimination value approaches one as the sample prediction images decrease in deviation from the sample reference images.

10. The method of claim 9, wherein the deep learning model is trained such that the discrimination value converges on 0.5.

11. The method of claim 1, wherein the sample input images further include images of edge portions of the sample layout patterns.

12. The method of claim 1, wherein the training operation is performed based on images obtained by increasing or decreasing a magnification of the sample input images with a plurality of scaling factors.

13. An optical proximity correction method comprising:
receiving a design layout including layout patterns used in a semiconductor process to form process patterns of a semiconductor device;
obtaining an optical proximity correction model associated with the design layout based on a deep learning model used in optical proximity correction; and
obtaining a corrected design layout including corrected layout patterns that correspond to the layout patterns based on the optical proximity correction model,
wherein the deep learning model is trained by:
obtaining sample input images associated with sample layouts, the sample layouts being targets of the optical proximity correction;
extracting sample reference images from sample masks that are fabricated by performing the optical proximity correction on the sample layouts, the sample reference images corresponding to the sample reference images; and
performing a training operation on the deep learning model based on the sample input images and the sample reference images,
wherein the sample layouts include sample layout patterns, and the sample input images include images of corner portions of the sample layout patterns, and
wherein the deep learning model is used to perform a corner rounding operation on the corner portions of the sample layout patterns and corner portions of the layout patterns.

14. The optical proximity correction method of claim 13, wherein obtaining the optical proximity correction model includes:
performing a biasing operation on edge portions of the layout patterns; and
performing the corner rounding operation on the corner portions of the layout patterns based on the deep learning model.

15. The optical proximity correction method of claim 14, wherein the biasing operation is performed by dividing the edge portions of the layout patterns into segments and by shifting at least one of the segments.

16. The optical proximity correction method of claim 15, wherein the biasing operation is performed by shifting a first segment along a first direction and by shifting a second segment along a second direction different from the first direction.

17. The optical proximity correction method of claim 14, wherein obtaining the optical proximity correction model further includes:
performing a verifying operation on the optical proximity correction model.

18. The optical proximity correction method of claim 17, wherein obtaining the optical proximity correction model further includes:
in response to the determining that the verifying operation is unsuccessful, changing at least a part of the optical proximity correction model.

19. A method of manufacturing a semiconductor device, the method comprising:
obtaining a design layout including layout patterns for semiconductor process to form process patterns of the semiconductor device;
forming a corrected design layout including corrected layout patterns corresponding to the layout patterns by performing optical proximity correction on the design layout;
fabricating a photomask based on the corrected design layout; and
forming the process patterns on a substrate using the photomask,
wherein forming the corrected design layout includes:
receiving the design layout;
obtaining an optical proximity correction model associated with the design layout based on a deep learning model used in the optical proximity correction; and
obtaining the corrected design layout based on the optical proximity correction model,
wherein the deep learning model is trained by:
obtaining sample input images associated with sample layouts, the sample layouts being targets of the optical proximity correction;
extracting sample reference images from sample masks that are fabricated by performing the optical proximity correction on the sample layouts, the sample reference images corresponding to the sample reference images; and
performing a training operation on the deep learning model based on the sample input images and the sample reference images,
wherein the sample layouts include sample layout patterns, and the sample input images include images of corner portions of the sample layout patterns, and
wherein the deep learning model is used to perform a corner rounding operation on the corner portions of the sample layout patterns and corner portions of the layout patterns.

20. The method of claim 19,
wherein the semiconductor device includes a plurality of layers that are stacked on each other, and
wherein the optical proximity correction is performed on each of the plurality of layers independently.
